(19) United States
(12) Patent Application Publication
(10) Pub. No.: US 2009/0089809 A1
(43) Pub. Date: Apr. 2, 2009

(54) AUTOMATIC GENERATION OF PARALLELIZABLE APPLICATION UNITS SYSTEM AND METHOD

(76) Inventors: Amod Dattatray Deshpande, Pune (IN); Sanjay Patel, Pune (IN)

Correspondence Address: Global IP Services, PLLC, 198 F, 27th Cross, 3rd Block, Jayanagar, Bangalore, Karnataka, 560011, IN

(21) Appl. No.: 11/862,205

(22) Filed: Sep. 27, 2007

(51) Int. Cl. G06F 9/44; G06F 7/00

(52) U.S. Cl. 719/320; 707/8; 707/E17.007

(57) ABSTRACT

A system and method for automatic generation of parallelizable application units is disclosed. In one embodiment, a method includes executing application binaries and dependencies having a hooked application method on a computer node of a cluster of a network, receiving a context of the hooked application method from a client of the network upon reaching a hook of the hooked application method during execution of the application binaries and the dependencies, executing the context of the hooked application method on the computer node, and generating results of the hooked application method on the computer node. The method may further include serializing the results on the computer node, and transmitting, via the network, the serialized results to the client. In addition, the method may include executing two or more hooked application methods in parallel.

### FIELD OF THE INVENTION

The present invention relates generally to computers and software and more particularly relates to techniques for automatic generation of parallelizable application units.

### BACKGROUND

A computer cluster may include a group of coupled computers that work together to execute computer software programs. The computer cluster, sometimes referred to as a “cluster”, may be logically viewed as a single computer. The cluster may be deployed, for example, to improve performance and/or availability over that provided by a single physical computer. In addition, the cluster may be more cost effective than the single physical computer having comparable speed or availability.

Some methods to develop applications for the cluster may rely primarily on concepts of inheritance and enforcement, sometimes referred to as the inheritance method. Alternatively, a framework may offer an aspect-oriented approach to decorate units of an application, sometimes referred to as application units, to be available for execution on the cluster. The aspect-oriented approach is sometimes referred to as the decorative method.

Under the inheritance method, the framework may provide a base class implementation of functionality that may be used by derived classes to make objects of the classes as independent application units of execution. The independent application units may be treated as parallelizable application units, i.e., application units capable of parallel execution, from a perspective of the cluster.

The inheritance method, however, may require a change in an object-oriented class design of the application. In addition, a base call implementation may be typically an “IS-A” type of relationship. Hence, the derived class may be expected to implement cluster-specific code.

Further, some object oriented languages may restrict multiple inheritance. The restriction may limit a number of base classes for the derived class. The framework based class may thus need to be the base class of the application base class. For this reason, the entire application may become cluster-aware, which may not be desirable.

Under the decorative method, the framework may provide a set of attributes. The set of attributes may be used to decorate various application units developed to be re-entrant. The decorative method, however, may require the application to be programmed specifically with a complete understanding of an underlying cluster system. In addition, a programmer may expend effort to program constraints necessary to enable the various application units to be re-entrant.

Still further, both the inheritance method and the decorative method may require application units to have an independent execution path. Each method may mandate a change in the basic structure of the application.

### BRIEF DESCRIPTION OF THE DRAWINGS

Example embodiments are illustrated by way of example and not limitation in the figures of the accompanying drawings, in which like references indicate similar elements and in which:

FIG. 1 is a framework view illustrating generation of results of a hooked application method on a computer node of a cluster through an application execution module, a method execution module and a results module, according to one embodiment.

FIG. 2 is a block diagram illustrating transmission of application binaries and dependencies from a client to a computer node via a network, according to one embodiment.

FIG. 3 is a block diagram illustrating execution of the application binaries and the dependencies on the computer node of the cluster, according to one embodiment.

FIG. 4 is a block diagram illustrating receiving a context of the hooked application method from the client upon reaching a hook of the hooked application method, according to one embodiment.

FIG. 5 is a block diagram illustrating generation of results of the hooked application method on the computer node, according to one embodiment.

FIG. 6 is a block diagram illustrating transmission of serialized results to the client, according to one embodiment.

FIG. 7 is a diagrammatic system view of a data processing system in which any of the embodiments disclosed herein may be performed, according to one embodiment.

FIG. 8A is a process flow of generating results of the hooked application method on the computer node of the cluster, according to one embodiment.

FIG. 8B is a continuation of the process flow of FIG. 8A, illustrating additional processes, according to one embodiment.

Other features of the present embodiments will be apparent from the accompanying drawings and from the detailed description that follows.

### DETAILED DESCRIPTION

A system and method for automatic generation of parallelizable application units is disclosed. In the following description, for purposes of explanation, numerous specific details are set forth in order to provide a thorough understanding of the various embodiments. It will be evident, however, to one skilled in the art that the various embodiments may be practiced without these specific details.

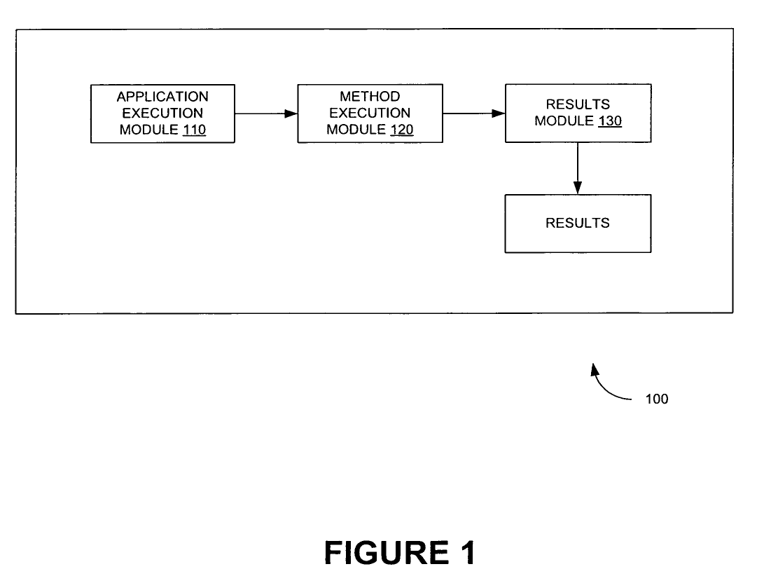

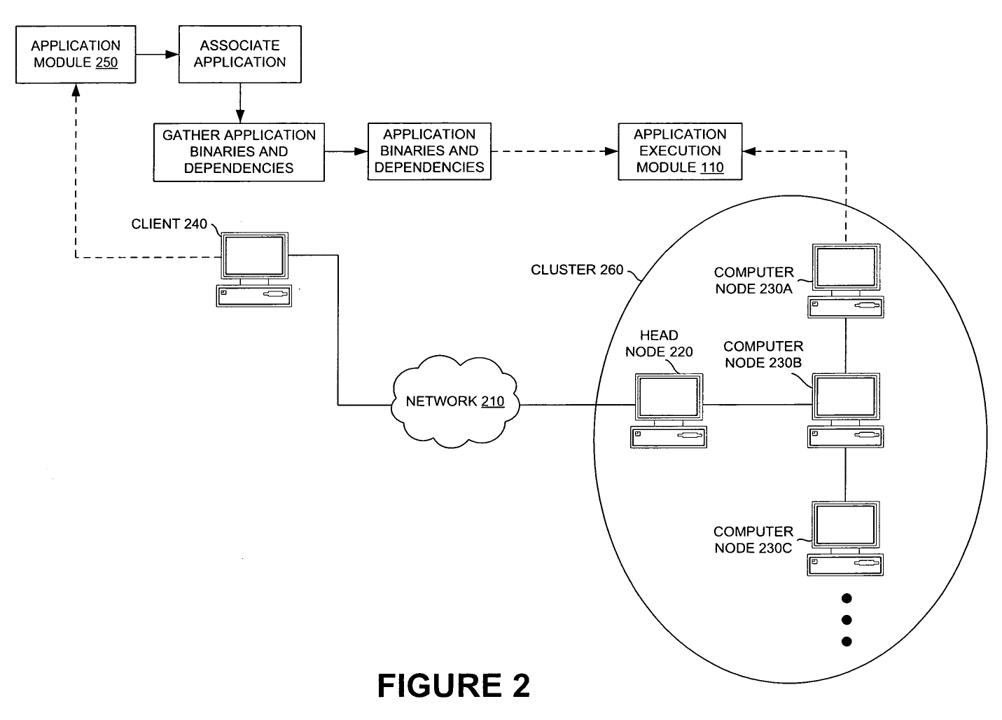

In one embodiment, a method includes executing application binaries and dependencies having a hooked application method on a computer node (e.g., one of the computer nodes 230A-C of FIG. 2) of a cluster (e.g., the cluster 260 of FIG. 2) of a network (e.g., the network 210 of FIG. 2), upon reaching a hook of the hooked application method during execution of the application binaries and the dependencies, receiving a context of the hooked application method from a client (e.g., the client 240 of FIG. 1) of the network 210, executing the context of the hooked application method on the computer node 230A, and generating results of the hooked application method on the computer node 230A.

In another embodiment, a system includes an application execution module (e.g., the application execution module 110 of FIG. 1) to execute, on a computer node (e.g., one of the computer nodes 230A-C of FIG. 2) of a cluster 260 of a network 210, application binaries and dependencies having a hooked application method, a method execution module (e.g., the method execution module 120 of FIG. 1) to receive a context of the hooked application method from a client and execute the context of the hooked application method on the computer node 230A, upon reaching a hook of the hooked application method during execution of the application binaries and the dependencies, and a results module (e.g., the results module 130 of FIG. 1) to generate results of the hooked application method on the computer node 230A.

In yet another embodiment, an article includes a storage medium having instructions, that when executed by a computing platform, result in execution of a method of generating parallelizable application units including executing application binaries and dependencies having a hooked application method on a computer node (e.g., one of the computer nodes 230A-C of FIG. 2) of a cluster (e.g., the cluster 260 of FIG. 2) of a network (e.g., the network 210 of FIG. 2), receiving a context of the hooked application method from a client (e.g., the client 240 of FIG. 2) of the network 210 upon reaching a hook of the hooked application method during execution of the application binaries and the dependencies, executing the context of the hooked application method on the computer node 230A, and generating results of the hooked application method on the computer node 230A.

FIG. 1 is a framework view 100 illustrating generation of results of a hooked application method on a computer node (e.g., the computer node 230A of FIG. 2) of a cluster (e.g., the cluster 260 of FIG. 2) through an application execution module 110, a method execution module 120 and a results module 130, according to one embodiment. Particularly, FIG. 1 illustrates the application execution module 110, the method execution module 120 and the results module 130.

The application execution module 110 executes application binaries and dependencies having the hooked application method on the computer node 230A of the cluster 260 of a network (e.g., the network 210 of FIG. 2). In some embodiments, the application binaries and the dependencies are gathered on a client (e.g., the client 240 of FIG. 2) and transmitted to the computer node 230A via the network 210 upon associating a first application with the client 240.

The method execution module 120 executes a context of the hooked application method on the computer node 230A upon receiving the context of the hooked application method from the client 240 (e.g., via the network 210). In some embodiments, the context is serialized on the client 240, transmitted, via the network 210 to the computer node 230A and deserialized on the computer node 230A prior to execution. In some embodiments, the method execution module 120 executes two or more hooked application methods on the different computer nodes 230A-C of the cluster 260 in parallel. Upon execution of the hooked application method on the computer node 230A, the results module 130 generates results. In some embodiments, the results are serialized on the computer node 230A and transmitted to the client 240 via the network 210. The client 240, for example, receives and deserializes the results.

In the example embodiment illustrated in FIG. 1, the framework includes the application execution module 110, the method execution module 120 and the results module 130 and generates results of the hooked application method.

FIG. 2 is a block diagram illustrating transmission of the application binaries and the dependencies from a client 240 to a computer node 230A via a network 210, according to one embodiment. Particularly, FIG. 2 illustrates a system that includes the application execution module 110, the network 210, a head node 220, the computer nodes 230A-C, the client 240, an application module 250 and a cluster 260.

FIG. 2 depicts a topology in which the head node 220 is on a public network and the cluster 260 of the computer nodes 230A-C is on a private network. The cluster 260 of the computer nodes 230A-C may be a group of loosely coupled computers deployed to work together closely for improving performance (e.g., speed) and/or availability. The computer nodes 230A-C are connected to the client 240 through the head node 220 and the network 210 such that two or more hooked application methods are executed in parallel using a multi-threading technique. The network 210 facilitates transmission of data (e.g., a serialized context, serialized results, etc.) between the client 240 and the computer nodes 230A-C through the head node 220. Various other topologies are contemplated.

In operation, the application module 250 associates a first application having a hooked application method with the client 240. The associating the first application may include providing hooks in the first application. In some embodiments, the application module 250 provides the hooks to enable a second application and/or a library to assume control over the first application during execution of the application binaries and the dependencies in the computer node 230A. In some embodiments, the hooks are provided using a partial class. In these embodiments, the partial class is used to provide the hooks into the first application through specification of a method name of a method (e.g., to be executed over the cluster 260 of computer nodes 230A-C).

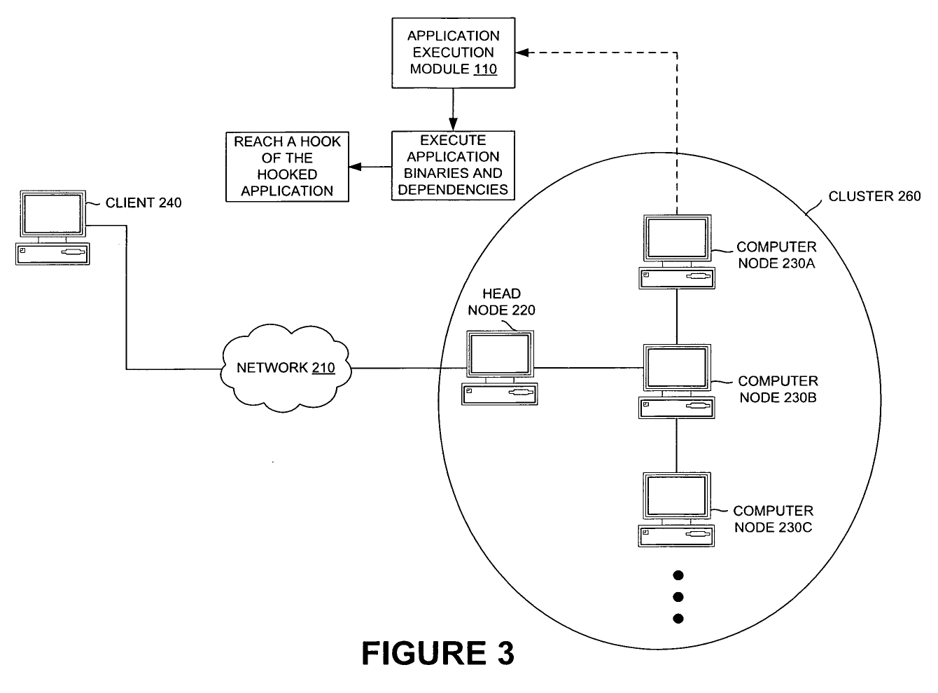

The application module 250 gathers the application binaries and the dependencies of the hooked application method from the first application in the client 240. The application binaries and the dependencies of the hooked application method are transmitted (e.g., using the application module 250 of FIG. 2) to the computer node 230A of the cluster 260 via the network 210. In some embodiments, the application binaries and the dependencies are transmitted via the head node 220 of the cluster 260 to the application execution module 110 of the computer node 230A of the cluster 260. Further operations, upon transmitting the application binaries and the dependencies to the computer node 230A are explained in detail in FIG. 3.

FIG. 3 is a block diagram illustrating execution of the application binaries and the dependencies on the computer node 230A of the cluster 260, according to one embodiment. Particularly, FIG. 3 illustrates a system that includes the application execution module 110, the network 210, the head node 220, the computer nodes 230A-C and the client 240.

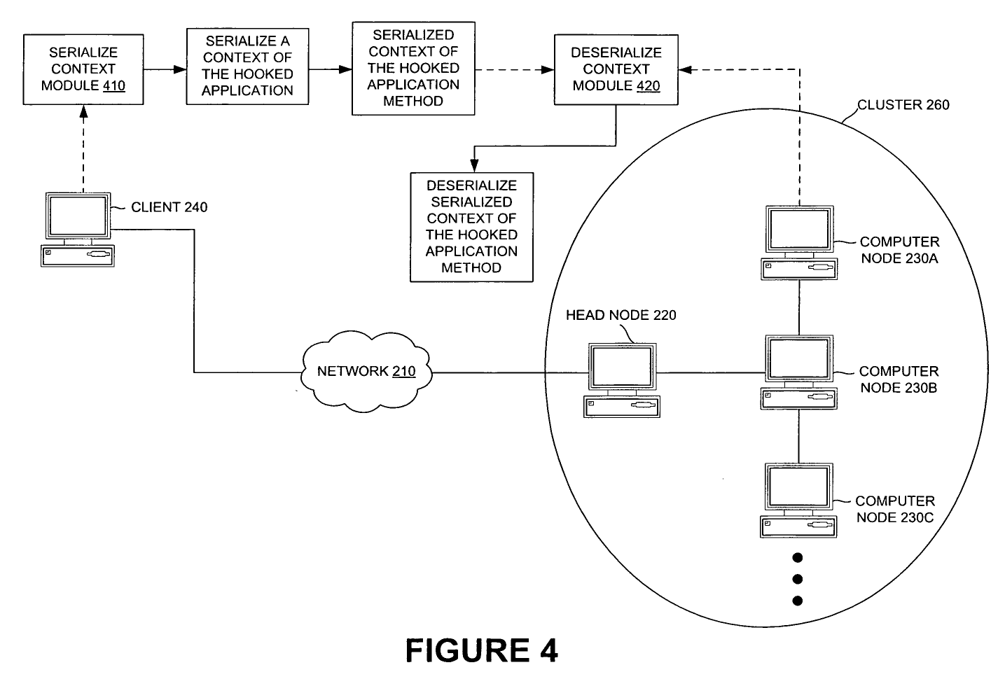

In operation, the application execution module 110 executes the application binaries and the dependencies received from the client 240 (e.g., through the head node 220) on the computer node 230A of the cluster 260. During the execution of the application binaries and the dependencies, application execution logic reaches a hook of the hooked application method. Operations performed upon reaching the hook of the hooked application method are explained in FIG. 4.

FIG. 4 is a block diagram illustrating receiving a context of the hooked application method from the client 240 upon reaching the hook of the hooked application method, according to one embodiment. Particularly, FIG. 4 illustrates system that includes the network 210, the head node 220, the computer nodes 230A-C, the client 240, a serialize context module 410 of the client 240 and a deserialize context module 420 of the computer node 230A.

In operation, the serialize context module 410 of the client 240 serializes the context of the hooked application method on the client 240. The serialized context is transmitted (e.g., using the serialize context module 410) to the computer node 230A of the cluster 260 via the network 210 where the serialized context of the hooked application method is deserialized through the deserialize context module 420 of the computer node 230A. In some embodiments, a callback is registered upon receiving the serialized context from the client 240. The above mentioned operations are performed upon reaching the hook of the hooked application method and during execution of the application binaries and the dependencies.

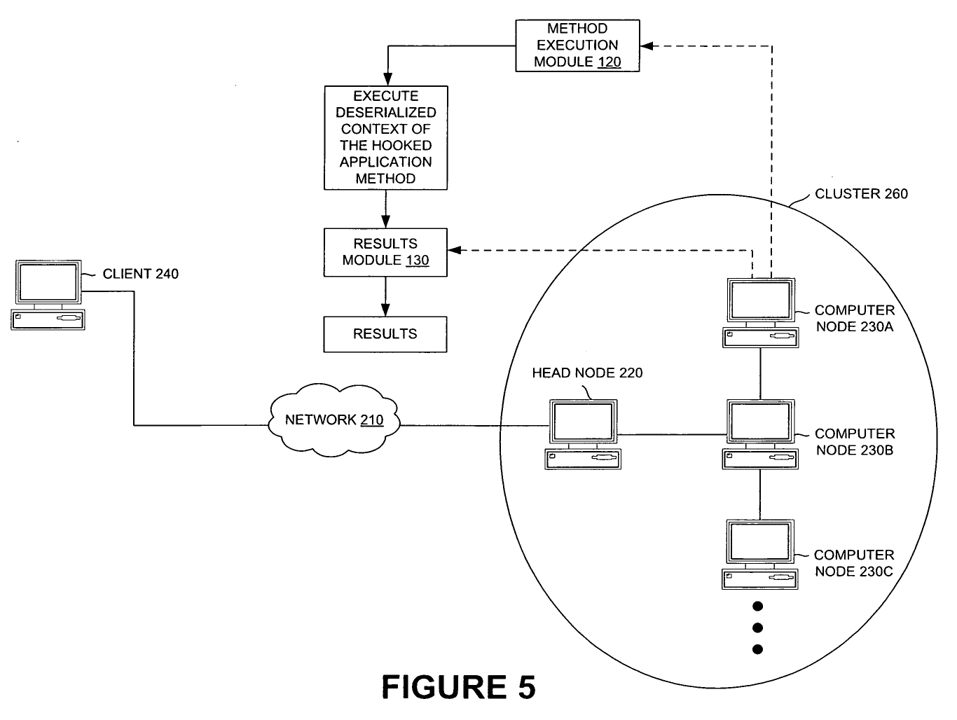

FIG. 5 is a block diagram illustrating generation of results of the hooked application method on the computer node 230A, according to one embodiment. Particularly, FIG. 5 illustrates a system that includes the method execution module 120, the results module 130, the network 210, the head node 220, the computer nodes 230A-C and the client 240.

In operation, the method execution module 120 of the computer node 230A executes the deserialized context of the hooked application method. In some embodiments, two or more hooked application methods are executed on the computer nodes 230A-C of the cluster 260 in parallel.

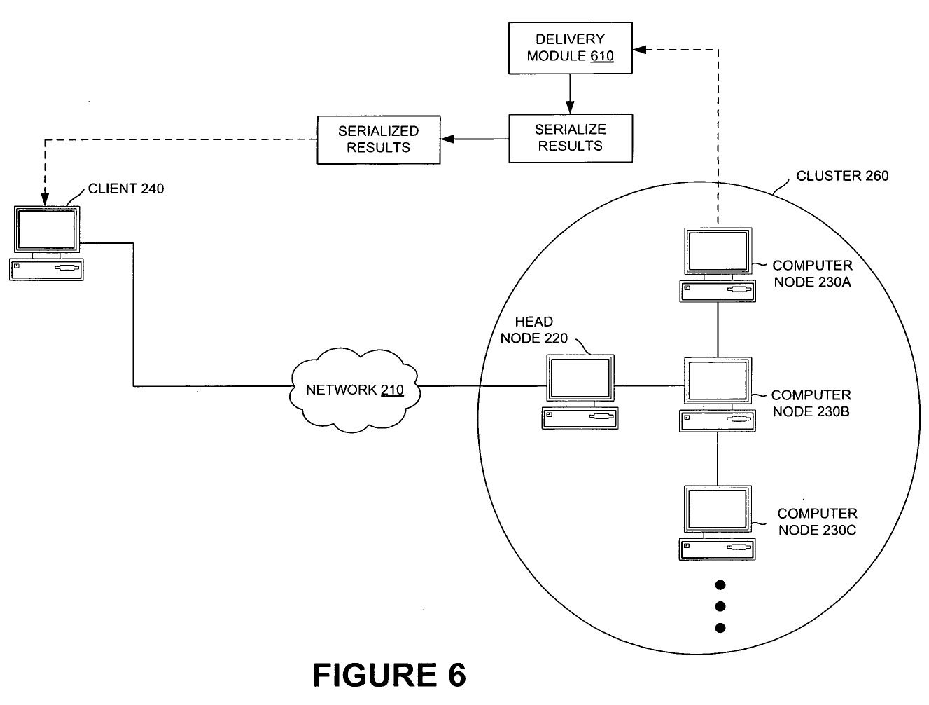

Upon execution of the deserialized context, the results module 130 generates results of the hooked application method on the computer node 230A. In some embodiments, the callback is invoked upon generation of the results of the hooked application method execution. In these embodiments, the callback in the application reloads the context into the hooked application method and further execution is triggered. Further operations of a method of generation of parallelizable application units are described in FIG. 6.

FIG. 6 is a block diagram illustrating transmission of serialized results to the client 240, according to one embodiment. Particularly, FIG. 6 illustrates a system that includes the network 210, the head node 220, the computer nodes 230A-C, the client 240 and a delivery module 610. In operation, the delivery module 610 serializes the results of the hooked application method on the computer node 230A. The serialized results are transmitted to the client 240 via the network 210 by the delivery module 610 of the computer node 230A of the cluster 260. In some embodiments, the serialized results are deserialized on the client 240.

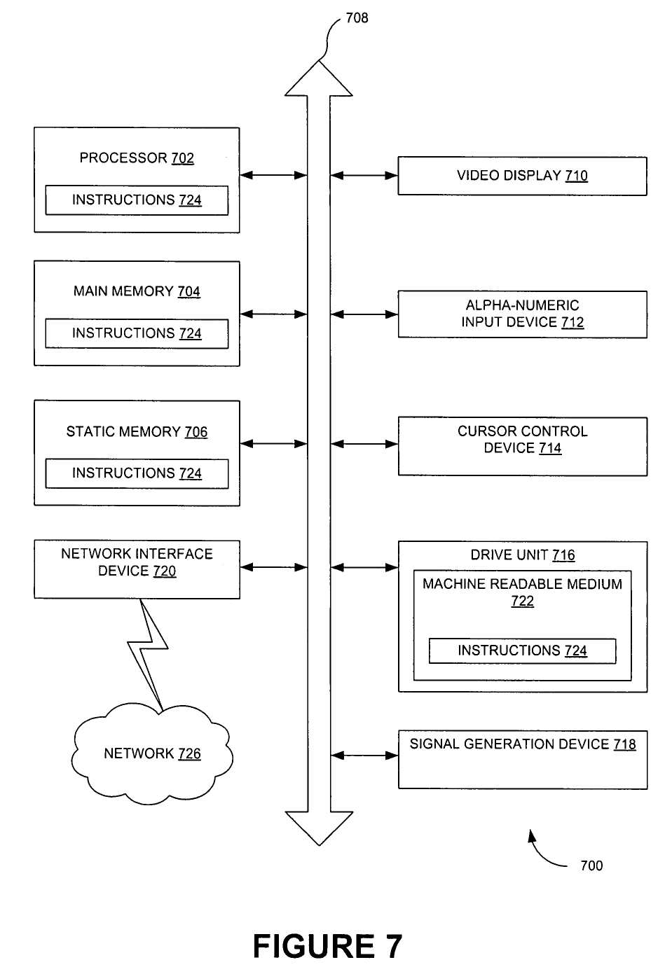

FIG. 7 is a diagrammatic system view 700 of a data processing system in which any of the embodiments disclosed herein may be performed, according to one embodiment. Particularly, the diagrammatic system view of FIG. 7 illustrates a processor 702, a main memory 704, a static memory 706, a bus 708, a video display 710, an alpha-numeric input device 712, a cursor control device 714, a drive unit 716, a signal generation device 718, a network interface device 720, a machine readable medium 722, instructions 724 and a network 726.

The diagrammatic system view 700 may indicate a personal computer and/or a data processing system in which one or more operations disclosed herein are performed. The processor 702 may be a microprocessor, a state machine, an application specific integrated circuit, a field programmable gate array, etc. The main memory 704 may be a dynamic random access memory and/or a primary memory of a computer system. The static memory 706 may be a hard drive, a flash drive, and/or other memory information associated with the data processing system.

The bus 708 may be an interconnection between various circuits and/or structures of the data processing system. The video display 710 may provide graphical representation of information on the data processing system. The alpha-numeric input device 712 may be a keypad, keyboard and/or any other input device of text (e.g., a special device to aid the physically handicapped). The cursor control device 714 may be a pointing device such as a mouse. The drive unit 716 may be a hard drive, a storage system, and/or other longer term storage subsystem.

The signal generation device 718 may be a bios and/or a functional operating system of the data processing system. The network interface device 720 may perform interface functions (e.g., code conversion, protocol conversion, and/or buffering) required for communications to and from the network 726 between a number of independent devices (e.g., of varying protocols). The machine readable medium 722 may provide instructions on which any of the methods disclosed herein may be performed. The instructions 724 may provide source code and/or data code to the processor 702 to enable any one or more operations disclosed herein.

For example, a storage medium having instructions, that when executed by a computing platform, result in execution of a method of generating parallelizable application units, the method includes executing application binaries and dependencies having a hooked application method on a computer node (e.g., one of the computer nodes 230A-C of FIG. 2) of a cluster (e.g., the cluster 260 of FIG. 2) of a network (e.g., the network 210 of FIG. 2), upon reaching a hook of the hooked application method during execution of the application binaries and the dependencies, receiving a context of the hooked application method from a client (e.g., the client 240 of FIG. 2) of the network 210, executing the context of the hooked application method on the computer node 230A, and generating results of the hooked application method on the computer node 230A.

The storage medium may have instructions to associate an application having a hooked application method with the client 240 of the network 210, gather the application binaries and the dependencies from the first application, and transmit, via the network 210, the application binaries and the dependencies to the computer node 230A. The storage medium may further have instructions to serialize the results on the computer node 230A, and transmitting, via the network 210, the serialized results to the client 240.

The receiving a context of the hooked application method from a client 240 of the network 210 upon reaching a hook of the hooked application method during execution of the application binaries and the dependencies includes serializing the context of the hooked application method on the client 240, transmitting, via the network 210, the serialized context of the hooked application method to the computer node 230A of the cluster 260, and deserializing the serialized context of the hooked application method on the computer node 230A. The storage medium may also have instructions to execute at least two hooked application methods in parallel.

Furthermore, a computer system includes a processing unit and a memory coupled to the processor. The memory has code stored therein for generating parallelizable application units. The code causes the processor to execute application binaries and dependencies having a hooked application method on a computer node 230A of a cluster 260 of a network 210, receive a context of the hooked application method from a client 240 of the network 210, upon reaching a hook of the hooked application method during execution of the application binaries and the dependencies, execute the context of the hooked application method on the computer node 230A, and generate results of the hooked application method on the computer node 230A.

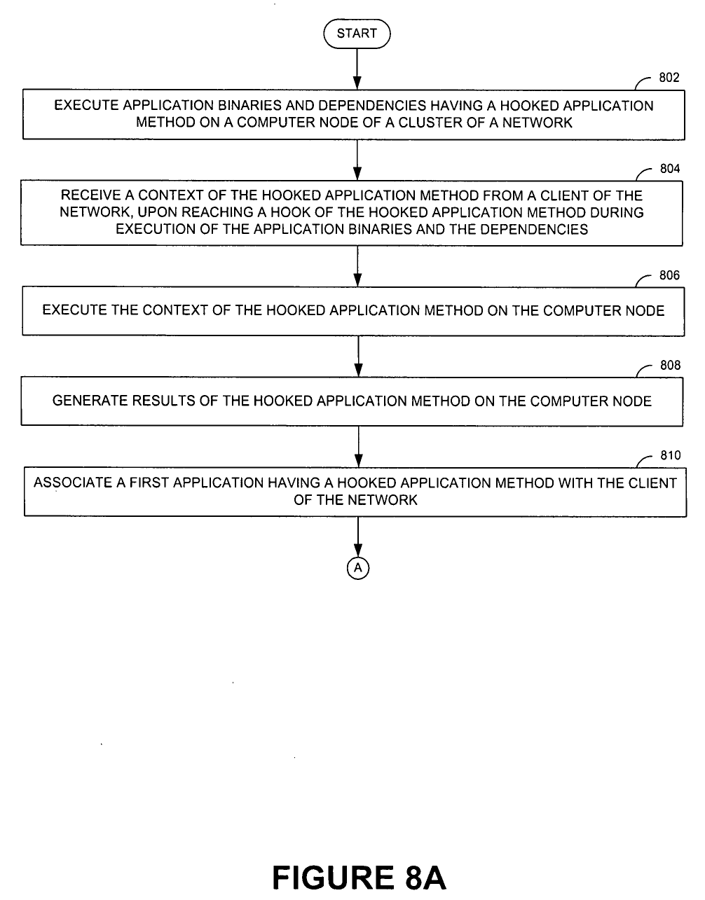

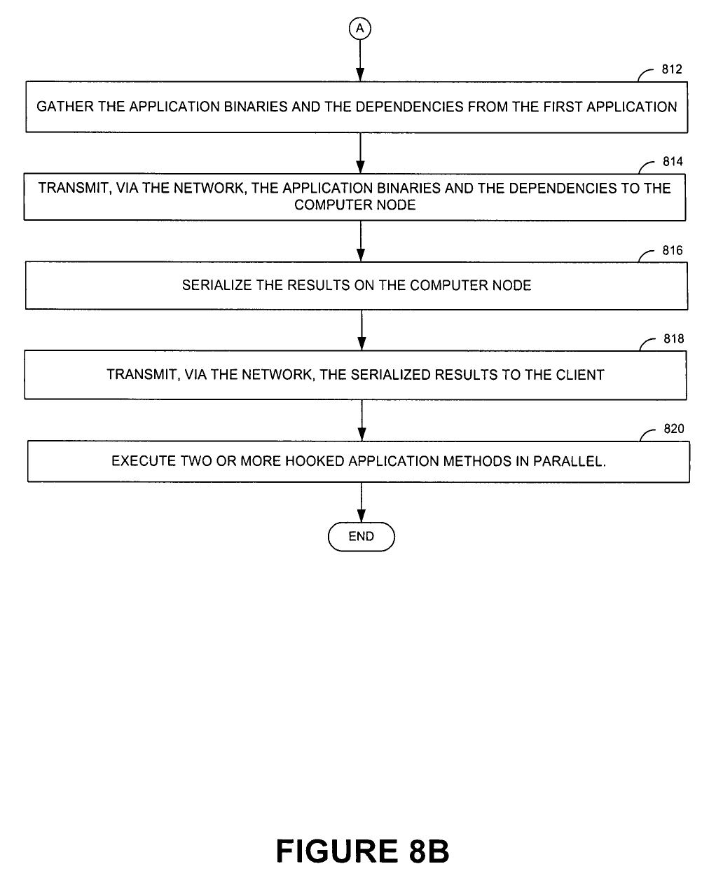

FIG. 8A is a process flow of generating results of a hooked application method on a computer node (e.g., one of the computer nodes 230A-C of FIG. 2) of a cluster (e.g., the cluster 260 of FIG. 2), according to one embodiment. In operation 802, application binaries and dependencies having the hooked application method are executed (e.g., through the application execution module 110 of FIG. 1) on the computer node 230A of the cluster 260 of a network (e.g., the network 210 of FIG. 2). In operation 804, a context of the hooked application method is received from a client (e.g., the client 240 of FIG. 2) of the network 210, upon reaching a hook of the hooked application method during execution of the application binaries and the dependencies.

In these embodiments, receiving the context of the hooked application method from the client 240 of the network 210 includes serializing the context of the hooked application method (e.g., through the serialize context module 410 of FIG. 4) on the client 240, transmitting, via the network 210, the serialized context of the hooked application method to the computer node 230A of the cluster 260, and deserializing the serialized context of the hooked application method (e.g., through the deserialize context module 420 of FIG. 4) on the computer node 230A.

In operation 806, the context of the hooked application method is executed on the computer node 230A. In some embodiments, the method execution module 120 is used to receive a context of the hooked application method from a client 240 and further execute the context of the hooked application method on the computer node 230A, upon reaching a hook of the hooked application method during execution of the application binaries and the dependencies. In operation 808, results of the hooked application method are generated (e.g., through the results module 130 of FIG. 1) on the computer node 230A.

FIG. 8B is a continuation of the process flow of FIG. 8A, illustrating additional processes, according to one embodiment. In operation 810, a first application having a hooked application method is associated with the client 240 of the network 210. In some embodiments, associating the first application having a hooked application method with a client 240 of the network 210 includes providing hooks in the first application to enable a second application and/or a library to assume control over the first application during execution.

In these embodiments, providing the hooks into the first application to enable a second application and/or a library to assume control over the first application during execution includes using a partial class to provide hooks into the first application through specification of a method name of a method to be executed over the cluster 260.

In operation 812, the application binaries and the dependencies are gathered from the first application. In operation 814, the application binaries and the dependencies are be transmitted, via the network, to the computer node. In some embodiments, the application module 250 is used to associate a first application having the hooked application method with the client 240, generate the application binaries and the dependencies from the first application, and transmit, via the network 210, the application binaries and the dependencies to the computer node 230A of the cluster 260.

In operation 816, the results are serialized on the computer node 230A. In operation 818, the serialized results are transmitted, via the network 210, to the client 240. In some embodiments, the delivery module 610 is used to serialize the results on the computer node 230A of the cluster 260 and transmit, via the network 210, the serialized results to the client 240. In operation 820, two or more hooked application methods may be executed (e.g., through the method execution module 120 of FIG. 1) in parallel.

The above technique facilitates abstraction of an application developer from intricacies of the cluster 260 of the computer nodes 230A-C and provides automatic generation of parallelizable application units. The above-described method does not require change in the basic structure of the application to generate the parallelizable application units. Further, the above technique uses an application probing technique to automatically generate the parallelizable application units. The application probing is a methodology for directly executing the application units with hooks made available at compile time. The application probing technique used in the above-described method includes context serialization (as illustrated in FIG. 4) and binary streaming techniques which enable the application units to be automatically generated and streamed across machine boundaries along with their memory context.

In some embodiments, the application probing technique relies on the hooks provided in the hooked application method to enable an external application and/or library assume control over the hooked application method during execution. In these embodiments, a partial class is used to provide the hooks into the hooked application method by specifying method names of methods that can be executed over the cluster 260.

The above technique provides a programmatic approach to automate the entire process and make the application cluster 260 ready. In some embodiments, during the execution of the application binaries and the dependencies when application execution logic reaches the hook of the hooked application method, a context of the hooked application method is serialized and sent over to the computer node 230A. In these embodiments, a result callback is registered at this point for the application notification. When the results are generated, the application callback is invoked and the results are serialized on the computer node 230A. In these embodiments, the callback in the application reloads the context into the hooked application method and further execution is triggered. In another embodiment, two or more hooked application method can be executed in parallel using a multi-threading technique.

In addition, the above technique provides applications that can leverage the capabilities of the cluster 260 on which the applications are targeted for deployment. The above-described method includes various steps for generating the parallelizable application units, viz. identifying parallelization within execution paths, compiling corresponding code into executables, ensuring an availability of the executables on the computer nodes 230A-C of the computer cluster 260, enabling data flow between the executables and an end user interface (e.g., the client 240 of FIG. 2), enabling communication between executables running in parallel, and creating and submitting required jobs and tasks.

The framework may automatically and intelligently create a job and related entities without a need for the application developer to define those explicitly. The framework may also address basic job monitoring, alert and/or reporting. In addition, the framework may also provide the application developer with a distributed computing solution that delivers improved performance for real-world business applications. In addition, the framework can be used in several mainstream enterprise computing applications. Furthermore, the framework may offer various features like task retry mechanism, callbacks on completion of tasks, ability to pass and receive serializable objects as parameters and results, inter-task communication, encapsulating High Performance Computing (HPC) platform complexities, ease of HPC development and integration, options to define tasks at method level or code back level, and detailed logging and reporting for application requests with scalability recommendations.

The various application scenarios supported by the framework include application probing based on hooks defined to execute a portion of code on the different computer nodes 230A-C involving context serialization and deserialization, applications designed for clustering in which isolation of task and jobs are part of an application design, and legacy applications code to be selectively tagged (e.g., using HPC keywords and preprocessor directives, etc.) to execute on a grid.

Also, the above described method may be in a form of a machine-readable medium embodying a set of instructions that, when executed by a machine, causes the machine to perform any method disclosed herein. It will be appreciated that the various embodiments discussed herein may not be the same embodiment, and may be grouped into various other embodiments not explicitly disclosed therein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
executing application binaries and dependencies having a hooked application method on a computer node of a cluster of a network;
upon reaching a hook of the hooked application method during execution of the application binaries and the dependencies, receiving a context of the hooked application method from a client of the network;
executing the context of the hooked application method on the computer node; and
generating results of the hooked application method on the computer node.

2. The method of claim 1, further comprising:
associating a first application having a hooked application method with the client of the network;
gathering the application binaries and the dependencies from the first application; and
transmitting, via the network, the application binaries and the dependencies to the computer node.

3. The method of claim 2, wherein the associating a first application having a hooked application method with a client of the network comprises providing hooks in the first application to enable at least one of a second application and a library to assume control over the first application during execution.

4. The method of claim 3, wherein the providing hooks into the first application to enable at least one of a second application and a library to assume control over the first application during execution comprises using a partial class to provide hooks into the first application through specification of at least one method name of a method to be executed over the cluster.

5. The method of claim 1, further comprising:
serializing the results on the computer node; and
transmitting, via the network, the serialized results to the client.

6. The method of claim 1, wherein the upon reaching a hook of the hooked application method during execution of the application binaries and the dependencies, receiving a context of the hooked application method from a client of the network comprises:
serializing the context of the hooked application method on the client;
transmitting, via the network, the serialized context of the hooked application method to the computer node of the cluster; and
deserializing the serialized context of the hooked application method on the computer node.

7. The method of claim 1, further comprising executing at least two hooked application methods in parallel.

8. The method of claim 1 in a form of a machine-readable medium embodying a set of instructions that, when executed by a machine, causes the machine to perform the method of claim 1.

9. A system, comprising:
an application execution module to execute, on a computer node of a cluster of a network, application binaries and dependencies having a hooked application method;
a method execution module to receive a context of the hooked application method from a client and execute the context of the hooked application method on the computer node, upon reaching a hook of the hooked application method during execution of the application binaries and the dependencies; and
a results module to generate results of the hooked application method on the computer node.

10. The system of claim 9, further comprising an application module to associate a first application having the hooked application method with the client, gather the application binaries and the dependencies from the first application, and transmit, via the network, the application binaries and the dependencies to the computer node of the cluster.

11. The system of claim 10, wherein the application module provides hooks into the first application to enable at least one of a second application and a library to assume control over the first application during execution.

12. The system of claim 10, wherein a partial class is used to provide the hooks into the first application through specification of at least one method name of a method to be executed over the cluster.

13. The system of claim 9, further comprising a delivery module to serialize the results on the computer node of the cluster and transmit, via the network, the serialized results to the client.

14. The system of claim 9, further comprising:
a serialize context module to serialize the context of the hooked application method on the client, transmit, via the network, the serialized context of the hooked application method to the computer node of the cluster: and
a deserialize context module to deserialize the serialized context of the hooked application method on the computer node of the cluster.

15. The system of claim 9, wherein the method execution module executes at least two hooked application methods in parallel.

16. An article, comprising:
a storage medium having instructions, that when executed by a computing platform, result in execution of a method of generating parallelizable application units, comprising:
executing application binaries and dependencies having a hooked application method on a computer node of a cluster of a network;
upon reaching a hook of the hooked application method during execution of the application binaries and the dependencies, receiving a context of the hooked application method from a client of the network;
executing the context of the hooked application method on the computer node; and
generating results of the hooked application method on the computer node.

17. The article of claim 16, further comprising:
associating an application having a hooked application method with a client of the network;
gathering the application binaries and the dependencies from the first application; and
transmitting, via the network, the application binaries and the dependencies to the computer node.

18. The article of claim 16, further comprising:
serializing the results on the computer node; and
transmitting, via the network, the serialized results to the client.

19. The article of claim 16, wherein the upon reaching a hook of the hooked application method during execution of the application binaries and the dependencies, receiving a context of the hooked application method from a client of the network comprise:
serializing the context of the hooked application method on the client;
transmitting, via the network, the serialized context of the hooked application method to the computer node of the cluster; and
deserializing the serialized context of the hooked application method on the computer node.

20. The article of claim 16, further comprising executing at least two hooked application methods in parallel.
